(19) United States
(12) Patent Application Publication
(10) Pub. No.: US 2024/0338623 A1
(43) Pub. Date: Oct. 10, 2024

(54) Method and Device for Estimating a Departure Time for use in an Intelligent Charging Process of Electric Vehicles

(71) Applicant: Robert Bosch GmbH, Stuttgart (DE)

(72) Inventor: Tjark Thien, Stuttgart (DE)

(21) Appl. No.: 18/579,413

(22) PCT Filed: Jul. 4, 2022
(86) PCT No.: PCT/EP2022/068423

§ 371 Date: Jan. 15, 2024

(30) Foreign Application Priority Data
Jul. 23, 2021 (DE) 10 2021 207 959.8

(51) Int. Cl. G06Q 10/0631; G06Q 50/40

(52) U.S. Cl. CPC G06Q 10/06315; G06Q 50/40

(57) ABSTRACT

A method is disclosed for ascertaining a departure time specification, which indicates the most probable departure time specification of an electric vehicle from a building, in order to determine a charging strategy for an electric energy storage device of the electric vehicle. The method includes providing a data-based departure time model which is trained to provide a departure time specification on the basis of a calendrical time specification and on the basis of one or more temporal load variable curves of vehicle-external load variables within a specified period of time. The one or more variable curves characterizes the usage of one or more energy loads, in particular a domestic appliance and/or a heating and hot water system, of the building. The method further includes analyzing the data-based departure time model by specifying the calendrical time specification and the one or more load variable curves within the specified period of time in order to determine the departure time specification.

### TECHNICAL FIELD

The invention relates to methods for controlling a charging process for rechargeable electrical energy storage devices, such as vehicle batteries of electric vehicles, and in particular to measures for estimating a departure time for improving energy management during a charging operation of an electrical energy storage device.

### TECHNICAL BACKGROUND

Electrical energy storage devices of electric vehicles, such as vehicle batteries, can be connected to a charging device, which is referred to as a wallbox, for charging. In the simplest case, this charging device charges the energy storage device from the time of connection until the energy storage device is fully charged.

However, the user often does not wish to use the electric vehicle again until later. This results in the possibility of optimizing the charging process. This aspect is referred to as intelligent charging.

In intelligent charging, the charging process is influenced by a control device in such a way that the existing chronological flexibility is utilized and added value is created. For example, with lower charging currents, a more careful charging of the energy storage device can be achieved. Furthermore, in case of variable electricity costs, the energy storage device can be charged at times when lower electricity costs are expected.

However, intelligent charging requires a scheduling of the charging process. One essential piece of information in this regard is knowledge of a most probable departure time at which the energy storage device is supposed to have reached a prespecified state of charge or be fully charged. The departure time generally corresponds to the time at which the vehicle is disconnected from the charging device.

### DISCLOSURE OF THE INVENTION

Provided according to the present invention is a method for determining a departure time for controlling a charging operation for an electrical energy storage device of an electric vehicle according to claim 1, as well as a corresponding device and a charging system according to the independent claims.

Further embodiments are specified in the dependent claims.

According to a first aspect, a method is provided for determining a departure time specification, which specifies a most probable departure time of an electric vehicle in order to determine a charging strategy for an energy storage device of the electric vehicle, having the following steps:
providing a data-based departure time model, which is trained to provide a departure time specification on the basis of a calendrical time specification and on the basis of one or more consumption variable curves of vehicle-external consumption variables within a predetermined period of time, with the one or more consumption variable curves characterizing a usage of one or more energy consumers, in particular a domestic appliance and/or a heating and hot water system of a building;
analyzing the data-based departure time model by prespecifying the calendrical time specification and the one or more consumption variable curves within the predetermined period of time in order to determine the departure time specification.

According to one embodiment, the departure time specification can be used in order to determine a charging strategy for the energy storage device. Typically, using data-based models, usage profiles for a charging device are analyzed in order to stochastically estimate a probable departure time. This is because the more accurately the departure time is predicted, the better an intelligent charging of an electrical energy storage device of the vehicle can be carried out.

For example, if the departure time is estimated too late, the state of charge desired by the user to achieve a minimum range cannot be achieved. However, if the departure time is estimated too early, the existing flexibility to adapt the charging process for cost and wear considerations is not optimally utilized. Thus, in an electric vehicle whose vehicle battery is preferably to be charged with electricity from its own photovoltaic system and whose user departs the next morning at 9:00 a.m., more electricity can be drawn from a photovoltaic system when the predicted departure time is predicted as accurately as possible for 9:00 a.m. the next morning. If an earlier departure time than 9:00 a.m. is predicted, e.g. 8:00 a.m., more mains electricity is drawn at night in order to charge the vehicle battery with the required minimum amount of energy until 8:00 a.m. If the predicted departure time is later, such as 10:00 a.m., the vehicle battery is not sufficiently charged, because the actual departure time is already one hour earlier.

Due to the complexity, machine learning methods are used in order to estimate the most probable departure time, which can predict future departure times on the basis of the historical data of vehicle movements and charging operations. This is done on the assumption that the user will continue to exhibit the same stochastic behavior in the future.

The accuracy of such a departure time model will depend significantly on the accuracy and regularity of the use of the electric vehicle. A disadvantage of such an implementation is thus that only stochastic behavior can be predicted, but not individual cases with differing behavior of the user. Such situations can occur when the user is not following their usual routine, but rather making an irregular journey. Examples of such exceptional driving can include the user leaving for work later in order to attend a doctor's appointment beforehand, or departing earlier in order to run errands while on the way to the gym.

Because such irregular journeys represent outliers from the normal stochastic behavior in the statistical sense, corresponding departure times cannot be determined using conventional methods or machine learning methods for departure time modeling.

Furthermore, a disadvantage of traditional data-based departure time models is that they require a very large database in order to be able to reliably model a departure time. In particular, in order to achieve the sufficient amount of training data, a longer input period is necessary, in which the real departure times are recorded and associated with corresponding input values of the data-based departure time model.

Through a home energy management system, consumption and usage data from energy consumers and/or a house energy supply can be acquired and provided via a plurality of sensors. For example, using an energy management system, a heat pump can be controlled so as to achieve as high a self-consumption as possible of the electricity generated by a dedicated photovoltaic system. For this purpose, the energy management system communicates with the inverter of the photovoltaic system in order to obtain all necessary information for controlling the heat pump.

Such an energy management system can further obtain, via further sensors, consumption data from individual devices in a building system and account for this in the energy management. In particular, a hot water consumption and the electricity consumption in the home can be determined via the heat demand, which enables conclusions to be drawn about user behavior. In particular, deviations from normal patterns of behavior can also be identified and interpreted on the basis of consumption variables in the building system.

For example, as such consumption variables, the following can be considered: hot water consumption specifications, such as start and stop values for hot water treatment and temperature readings of the hot water tank, electricity consumption curves of domestic energy consumers, as well as other electricity consumption events, such as fresh water supply and the like, individual events due to switching on individual consumers, such as the coffee maker, and other events detected or controlled by a smart home system, such as triggering of a motion sensor.

In order to detect deviations in the consumption variables from conventional patterns, the consumption variable curves can be analyzed with respect to outliers with an outlier detection model, in particular using machine learning methods such as cluster analysis, a neural network, a hidden Markov model, and the like.

The curves of the consumption data can be evaluated with regard to a prespecified period of time, for example a 24-hour period of time, in order to train a respective usage profile in the outlier detection model. The particular outlier detection model then allows for the detection of outliers in the curve of the particular consumption variable.

The departure time model is trained so to typical sequences in a usage pattern for the vehicle are analyzed. Thus, a calendrical time specification and an arrival time can be associated with a most probable departure time. By additionally providing one or more consumption variable curves within the prespecified period of time and indicating whether the respective consumption variable profile comprises an outlier from the conventional consumption variable profile, user behavior that deviates from the routine (stochastic) can be detected early, and the most probable departure time can be determined with a corresponding deviation taking into consideration the one or more consumption variable curves. A consumption variable curve corresponds to a temporal curve of a variable that can signal an energy consumption.

Thus, deviations from the usage pattern can be detected by monitoring the one or more consumption variables using the outlier detection model and signaling them to the departure time model. The departure time model can be trained to output a departure time on the basis of a calendrical time specification, an arrival time, and information on one or more consumption variable curves within the prespecified period of time. The departure time is determined for a common usage pattern, which can be detected from the consumption variable curves. The departure time corresponds to a regular or most probable departure time, which is substantially based on the last arrival time and the calendrical time specification.

The departure time model can be further trained to the departure time specification on the basis of one or more outlier signals, each of which specifies a deviation of one of the consumption variable curves from a regular pattern, with the data-based departure time model providing the departure time specification on the basis of the one or more outlier signals.

It can be provided that the outlier signal is determined by a trained outlier detection model on the basis of a corresponding consumption variable curve, with the outlier detection model comprising a clustering method and in particular an OPTICS algorithm for outlier detection.

Furthermore, the consumption variable curves can be provided by an energy management system for a building system. In particular, the one or more consumption variable curves can comprise information on energy consumption in a building system or usage-based variables, in particular of a hot water temperature of a heating system.

The departure time model can be further trained to provide the departure time specification on the basis of one or more smart home event signals, with the data-based departure time model providing the departure time specification on the basis of the one or more smart home event signals.

Provided according to a further aspect is a method for training a model in order to determine a departure time specification, which specifies a most probable departure time of an electric vehicle in order to determine a charging strategy for an energy storage device of the electric vehicle, having the following steps:
providing training datasets which associate a calendrical time specification and one or more consumption variable curves (V1, V2) of vehicle-external consumption variables within a predetermined period of time, each of which specifies a consumption-based or usage-based variable, with a departure time specification (AB);
training the departure time model using the training datasets.

### BRIEF DESCRIPTION OF THE DRAWINGS

Embodiments are explained in greater detail hereinafter with reference to the accompanying drawings. Shown are:

FIG. 1 a schematic representation of a system having an energy management device in a building system, with a charging device;

FIGS. 2a-2c, diagrams for representing the energy supply from different energy sources and a state of charge of the energy storage device during a charging operation;

FIG. 3 a diagram for representing the temporal profile of consumption variable curves with patterns signaling a departure time;

FIG. 4 a functional diagram illustrating the function of the model for determining the departure time specification for the electric vehicle; and

FIG. 5 a flowchart illustrating a method for training a departure time model of the building system on the basis of a method for estimating an expected departure time of an electric vehicle.

### DESCRIPTION OF THE EMBODIMENTS

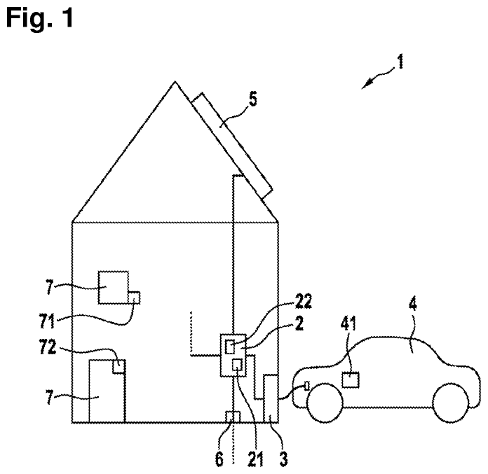

FIG. 1 shows a building system 1 having an energy management system 2 and a charging device 3 for an electric vehicle 4. The charging device 3 (also called a wallbox) is used in order to charge an electrical energy storage device 41 of the electric vehicle 4. The charging device 3 serves to provide charging energy for the electrical energy storage device 41 of the electric vehicle 4.

The energy management system 2 can control the use of electrical energy from various energy sources. For example, the energy management system 2 is in communication with a photovoltaic system 5 and a mains connection 6 in order to draw electrical energy for the operation of consumers 7 in the building system 1.

The charging device 3 is in communication with and is controlled by the energy management system 2, so that the charging times, the charging current, and the source of the electrical energy for charging the electrical energy storage device 41 can be prespecified.

The energy management system 2 is fundamentally designed to detect a plurality of variables and to recharge an electric vehicle connected to the charging device 3 according to a prespecified or variable charging profile (charging current as a function of the state of charge). For this purpose, the flow of energy from the charging device 3 into the electric vehicle 4 is prespecified in a controlled manner.

The energy management system 2 also has the task of specifying the charging strategy for charging the energy storage device 41 and carrying out the charging of the energy storage device 41 of the electric vehicle 4 in a cost-efficient and low-wear manner. Accordingly, the charging operation is carried out in such a way that the charging energy is drawn from a source that can be obtained as cost-effectively as possible. This can be, for example, electrical energy from the photovoltaic system 5, instead of using the electrical network. One criterion for a low-wear charging operation can be that the amount of time during which the energy storage device 41 is in a fully charged state when not in use is reduced.

One essential piece of information for determining a charging strategy is to know an anticipated probable departure time (time of disconnection from charging device 3) of the electric vehicle 4. Up to this time, a sufficient amount of electrical energy must be stored in the energy storage device 41. The charging strategy thus depends significantly on the accuracy of the prediction of the probable departure time of the electric vehicle 4. For this purpose, the energy management system 2 comprises a charging strategy unit 21, which, on the basis of an estimated departure time, defines the charging strategy for the energy storage device 41 in a prespecified and inherently known manner. The charging strategy substantially corresponds to the prespecification of a temporal curve of the charging current, in particular on the basis of a calendrical time prespecification, in particular the clock time (optionally in conjunction with the charging current).

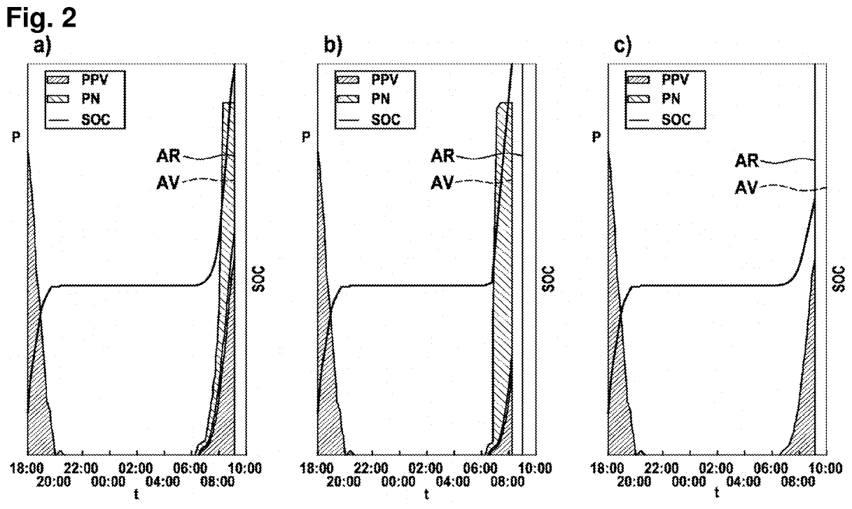

For example, FIG. 2a shows a possible charging strategy for charging a vehicle battery as an energy storage device 41 with network electricity and photovoltaic electricity for a preferred scenario. The charging power attributable to the photovoltaic current is specified by the PPV curve, the charging power attributable to the electrical network is specified by the PN curve, and the state of charge profile is specified by the SOC curve.

FIG. 2a shows a case where the predicted departure time AV corresponds to the actual departure time AR. It can be seen that the charging of the electric vehicle 4 is preferably performed using photovoltaic current. For this purpose, during the night, the charging process is interrupted, and the times in which photovoltaic electricity is available are predominantly used.

FIG. 2b shows a case where, with the same charging strategy, the actual departure time AR is after the estimated departure time AV. It can be seen that the charging operation is ended according to plan at the estimated departure time AV, i.e. at 9:00 a.m. Because photovoltaic energy is increasingly available, in this case, a possible potential for charging via photovoltaic electricity remains unused and a high proportion of network electricity is drawn instead.

FIG. 2c shows the reverse case, where the actual departure time AR is before the estimated departure time AV and, in this case, the desired state of charge SOC of the energy storage device 41 has not been achieved.

The latter scenarios are disadvantageous, but cannot be avoided with an inaccurate estimation of the departure time. Thus, an accurate estimation of the departure time is essential in order to be able to adapt the charging strategy in an improved manner.

The energy management system 2 can comprise a departure time estimation device 22 that transmits the departure time specification to the charging strategy unit 21. In order to determine the probable or expected departure time, the departure time estimation unit 22 includes a departure time model, which is trained on the basis of historical usage data and thus determines, on the basis of a calendrical time specification and a last arrival time of the electric vehicle 4, i.e., the point in time at which the electric vehicle 4 was connected to the charging device 3, determines a departure time specification, which specifies the expected departure time.

The energy management system 2 is connected to a plurality of energy consumers 7 in order to allocate electrical energy as needed and to measure the power consumption using consumption measurement units 71 and/or to detect the respective operating state using other operating state sensors 72 (such as temperature sensor of the hot water system). Thus, consumption information of the building system 1 is obtained in the form of temporal consumption variable curves. For example, the energy management system 2 can continuously obtain a temperature of the hot water reservoir. In addition, further information on the hot water system, such as start and stop temperatures and the supply temperature of the heating and hot water system, the heating mode, etc., can be provided in order to derive consumption variable curves of the heating system from the usage-based sensor data.

Also, the temporal profile of the power usage of electrical current by the household appliances can be provided as a consumption variable curve. A characteristic consumption variable curve can indicate an operation of a particular domestic appliance, such as turning on a coffee machine, or the like.

The operation of the specific household device can be related to a possible departure time, so characteristic portions of the consumption variable curve can indicate an impending departure time and can have a regular chronological relationship with the latter. As a result, a specific behavior of the user with respect to a possible departure time can be derived on the basis of the curve of the consumption variable, in particular electrical consumption.

For example, the energy management system 2 can make its determinations on the basis of regularly recurring events, such as driving to work on a weekday starting at 8:00 a.m. This is related to the use of the coffee maker at 7:00 a.m. If the usage behavior of the building system changes because, e.g., the start of the user's journey begins already at 7:00 a.m., then this can possibly already be determined by switching on the coffee machine at 6:00 a.m. The use of the hot water system can also deviate from the typical use of the hot water system in a corresponding manner.

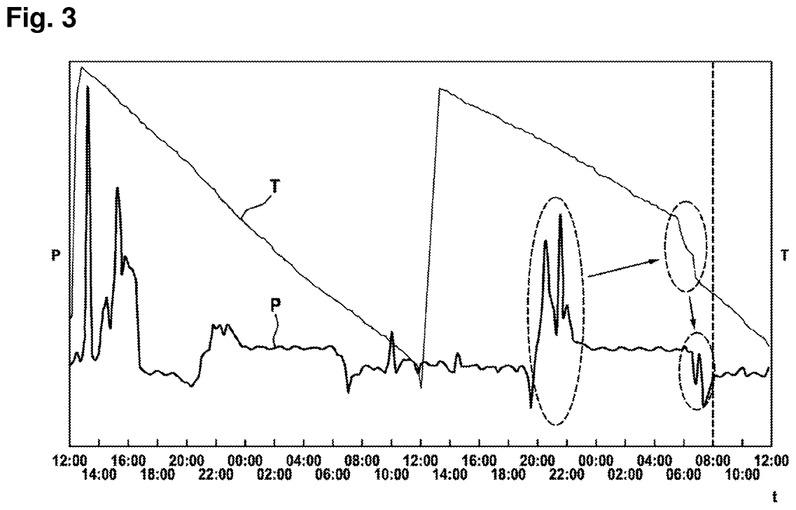

For example, FIG. 3 shows the curve of the temperature T of the hot water reservoir and the electricity consumption (Power P) of domestic appliances as energy consumers 7 for a predetermined period of time of 24 hours. A recognizable hot water tank temperature pattern exists that can, e.g., indicate shower use and electricity consumption, which can indicate the operation of a coffee machine. These patterns can signal an impending departure time. These consumption variable curves can therefore also be used to predict an expected departure time.

FIG. 4 shows a schematic representation of a model 10 for determining a departure time specification AB, which specifies an expected departure time. The model 10 comprises a departure time model 11, which is designed as a data-based model, in particular as a recurrent network, e.g., as an LSTM, GRU, or the like, so that the continuous temporal curves are prespecified on the input side in order to model a corresponding expected departure time.

The departure time model 11 is prespecified with a calendrical time specification Z, an arrival time specification A, which supplies a start time of a charging operation of the electric vehicle 4, and one or more consumption variable curves V1, V2. The consumption variable curves can, e.g., comprise the trend of electrical energy consumption by household appliances, and a temperature of the hot water reservoir. The departure time model 11 is trained in order to correspondingly output an expected departure time specification AB.

In order to support the data-based model 10, the consumption variable curves can be analyzed for deviations from conventional curve patterns in a respective outlier detection model 12 in order to detect outliers and signal them as outlier signals. This can, e.g., be performed by way of evaluation using cluster analysis. The cluster analysis detects whether the consumption variable curves within the predetermined period of time substantially have a comparable pattern to consumption variable curves for cycles of previously determined time durations.

To evaluate the departure time model 11, it is sufficient to provide the temporal curves of the calendrical time specification, the consumption variable curves, and, optionally, the arrival time A and event signals of smart home events within a previous time period of preferably 24 hours (predetermined period of time), because many human processes repeat themselves in a 24-hour cycle.

An OPTICS algorithm can be used in order to analyze the curve data of the 24-hour cycle for outliers. If the last 24 hours of the consumption variable curves deviate significantly from an ordinary pattern, an extraordinary user behavior is assumed, and this is provided as an input to the data-based departure time model 11.

Given that deviations in consumption variable curves generally occur significantly before an actual departure time, but can be related thereto, the estimation of the departure time specification AB can be adapted early on to a changed pattern of a consumption variable curve, and the charging strategy can optionally be adapted such that the energy storage device 41 is sufficiently charged in a timely manner in each case.

In addition, smart home events, such as triggering a door contact or triggering a motion sensor, which are centrally available as a signal in the energy management system 2, can be provided as input parameters for the departure time model 11.

For training the data-based model, historical consumption variable curves and the departure and arrival times can be detected and used for the training. Training data are generated by associating training datasets consisting of a temporal curve of a calendrical time specification of the one or more consumption variable curves with a departure time specification. In addition, corresponding outliers signaled by one or more outlier signals (outliers of consumption variable curves within the predetermined period of time) can be part of the training datasets. For this purpose, the corresponding outlier detection models 12 can be trained in advance with a plurality of cycles from consumption variable curves in order to also have the corresponding outlier signal available for the training of the departure time model 11 in addition to the consumption variable curves V1, V2.

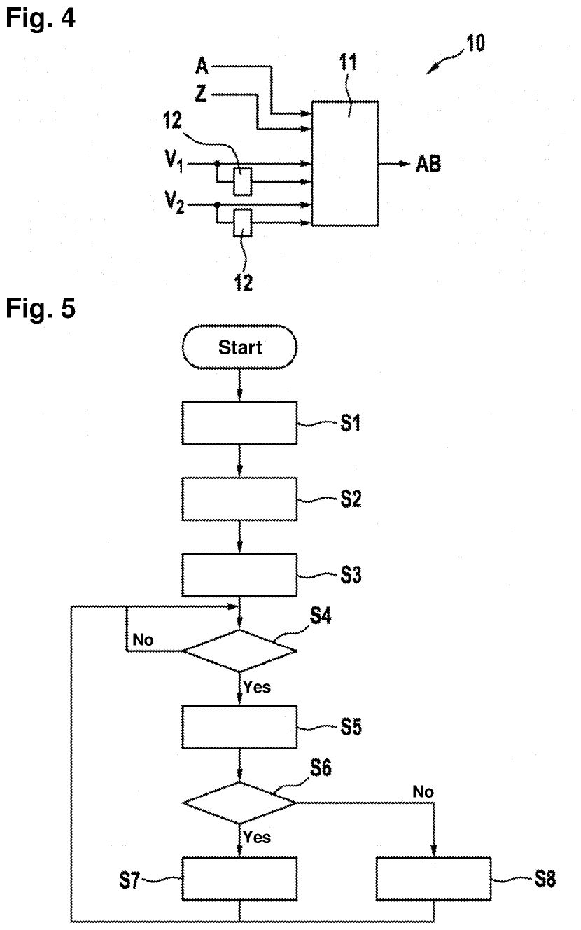

A possible training method is described in further detail by way of an example on the basis of the flowchart in FIG. 5.

In step S1, training datasets are provided, as described hereinabove. The training datasets comprise consumption variable curves for the predetermined period of time and an associated departure time specification.

In step S2, the consumption variable curves are additionally analyzed for outliers, and a respective outlier signal is provided for each of the consumption variable curves added to the training dataset.

In step S3, the departure time model 11 is trained using the training datasets. The training can be performed using a training method typical for data-based models utilizing back-propagation.

Regular retraining is performed in order to continuously adapt the data-based departure time model 11 to the actual user behavior.

In step S4, it is checked whether a sufficient (prespecified) number of new training datasets are available. If this is the case (alternative: Yes), then the retraining is performed in step S5, otherwise step S4 is revisited.

The retraining can be performed in step S5 in a conventional manner on the basis of new training data, in which case a portion of the training datasets are used not for training, but only for validation of the departure time estimation model.

By comparing the departure time specifications contained in the validation data to modeled departure time specifications on the basis of the validation data, it can be verified in step S6 whether a resulting forecast error above a prespecified threshold value can be ascertained. Based on the forecast error, it is then decided whether the retrained departure time model 11 has been improved over the previously existing departure time estimation model 11. If this is the case (alternative: Yes), then the newly trained departure time estimation model is adopted in step S7 and the method is continued with step S4. If this is not the case (alternative: No), then the newly trained departure time estimation model is discarded in step S8 and the method is continued with step S4.

1-11. (canceled)

12. A method for ascertaining a departure time specification, which specifies a most probable departure time specification of an electric vehicle from a building, in order to determine a charging strategy for an electrical energy storage device of the electric vehicle, comprising:
providing a data-based departure time model which is trained to provide a departure time specification on the basis of a calendrical time specification and on the basis of one or more temporal consumption variable curves of vehicle-external consumption variables within a specified period of time, wherein the one or more consumption variable curves characterize a usage of one or more energy consumers,
wherein the departure time model is further trained in order to provide the departure time specification on the basis of one or more outlier signals, each of which specifies a deviation by one of the consumption variable curves from a regular pattern, wherein the data-based departure time model provides the departure time specification on the basis of the one or more outlier signals, wherein the one or more outlier signals are determined by a respective trained outlier detection model on the basis of a corresponding consumption variable curve; and
analyzing the data-based departure time model by prespecifying the calendrical time specification and the one or more consumption variable curves within the specified period of time in order to determine the departure time specification.

13. The method according to claim 12, wherein the one or more consumption variable curves comprise information on energy consumption in a building system or usage-based variables of a hot water temperature of a heating system.

14. The method according to claim 12, wherein the departure time specification is used in order to determine a charging strategy for the energy storage device.

15. The method according to claim 12, wherein the consumption variable curves are provided by an energy management system for a building system.

16. The method according to claim 12, wherein the departure time model is further trained in order to provide the departure time specification on the basis of one or more smart home event signals, wherein the data-based departure time model provides the departure time specification on the basis of the one or more smart home event signals.

17. A method for training a model to determine a departure time specification, which specifies a most probable departure time specification of an electric vehicle in order to determine a charging strategy for an energy storage device of the electric vehicle, comprising:
providing training datasets which associate a calendrical time specification, one or more consumption variable curves of vehicle-external consumption variables within a specified period of time, each of which specifies a consumption-based or usage-based variable, and one or more outlier signals, each of which specifies a deviation by one of the consumption variable curves from a regular pattern, with a departure time specification; and
training the departure time model using the training datasets.

18. A device for ascertaining a departure time specification, which indicates a most probable departure time specification of an electric vehicle from a building, in order to determine a charging strategy for an energy storage device of the electric vehicle, wherein the device is designed to:
provide a data-based departure time model, which is trained to provide a departure time specification on the basis of a calendrical time specification and one or more consumption variable curves of vehicle-external consumption variables within a specified period of time, wherein the one or more consumption variable curves characterize a usage of one or more energy consumers, wherein the departure time model is further trained to provide the departure time specification on the basis of one or more outlier signals, each of which indicates a deviation by one of the consumption variable curves from a regular pattern, wherein the data-based departure time model provides the departure time specification on the basis of the one or more outlier signals, wherein the outlier signal is determined by a trained outlier detection model on the basis of a corresponding consumption variable curve; and
analyze the data-based departure time model by prespecifying the calendrical time specification and the one or more consumption variable curves within the specified period of time in order to determine the departure time specification.

19. A computer program product comprising commands which, when the program is performed by a computer, prompt the computer to perform the method steps according to claim 12.

20. A machine-readable storage medium comprising commands which, when performed by a computer, prompt the computer to perform the method steps according to claim 12.

21. The method according to claim 12, wherein the one or more consumption variable curves characterize a usage of a domestic appliance and/or a heating and hot water system of the building.

22. The device according to claim 18, wherein the one or more consumption variable curves characterize a usage of a domestic appliance and/or a heating and hot water system of the building.
